(19) United States
(12) Patent Application Publication
(10) Pub. No.: US 2005/0188394 A1
(43) Pub. Date: Aug. 25, 2005

(54) Optical pick-up apparatus with lenses

(75) Inventor: In Ho Choi, Seongnam-si (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017-5554, US

(73) Assignee: LG Electronics Inc.

(21) Appl. No.: 11/059,257

(22) Filed: Feb. 15, 2005

(30) Foreign Application Priority Data
Feb. 19, 2004 (KR) 11097/2004

(51) Int. Cl. G11B 7/08

(52) U.S. Cl. 720/683; 369/44.22; 720/681; 369/44.15; 720/682

(57) ABSTRACT

There is provided an optical pick-up apparatus with a plurality of lenses, in which an actuator is carried to place a specific lens of a lens holder on an optical axis. In the optical pick-up apparatus, the actuator has the plurality of lenses to focus lasers with different wavelengths on a track of a disk according to the type of the disk, and a linear driving unit carries the actuator to place one of the lenses on a laser path.

### BACKGROUND OF THE INVENTION

1. Field of the Invention

The present invention relates to an optical pick-up apparatus, and more particularly, to an optical pick-up apparatus with a plurality of lenses, in which an actuator with a plurality of lenses is capable of linear reciprocating motion.

2. Description of the Related Art

Usage of high-quality and big-size moving pictures is becoming very common, and accordingly the capacity of optical disk has been increasing. For example, an optical system utilizing a short wave blue laser (e.g., 405 nm) has been developed.

Further, to use a blue laser disk (BD) together with a compact disk/digital video [versatile] disk (CD/DVD), an optical pick-up system with a blue laser lens together with a red laser lens has been developed.

FIG. 1 is a perspective view of an axle-type optical pick-up actuator with a dual lenses according to the related art, and FIG. 2 is an exploded perspective view of an axle-type optical pick-up actuator depicted in FIG. 1.

Referring to FIGS. 2 and 3, an axle-type optical pick-up actuator includes a circular lens holder 104, a focusing coil 106, tracking coils 108, a yoke 112, metal pieces 114, a balancing weight 116, and a shaft 18.

The lens holder 104 holds a dual lens 102 with different lens. The coils 106 and 108 together with magnets 110 generate a driving force to align the dual lens 102 of the lens holder 104 with a signal track of a disk. The magnets 110 attach to the inner surface of the yoke 112, and the yoke 112 defines a beam hole 120 in which a laser passes. The metal pieces 114 are disposed inside of the tracking coils 108 to dampen rotation of the lens holder 104. The balancing weight 116 is disposed on the lens holder 104 to align the mass center and the geometric center of the lens holder 104. The shaft 118 has one end-fixed to the yoke 112 and the other end inserted into the lens holder 104.

The dual lens 102 includes different object lenses. For example, the dual lens 102 includes object lenses 101 and 103, and the object lens 101 may be a red laser lens for CD/DVDs, and the object lens 103 may be a blue laser lens for blue laser disks.

Referring again to FIGS. 1 and 2, the lens holder 104 has a cylindrical or disk shape. The lens holder 104 includes object lenses 101 and 103 (dual lens 102) arranged at an angle of 90 degrees to each other. The object lens 101 may be a red laser lens for CD/DVDs, and the object lens 103 may be a blue laser lens for blue laser disks. Also, the lens holder 104 includes the balancing weight 116 opposite to the dual lens 102 for mass balance.

The focusing coil 106 is wounded around the lens holder 104, and the tracking coils 108 are arranged on the outer surface of the focusing coil 106. Also, the metal pieces 114 are disposed inside of the tracking coils 108, respectively.

The yoke 112 is coupled with the lens holder 104. The yoke includes vertically extended parts. The magnets 110, corresponding to the tracking coils 108, are attached to inner surfaces of the extended parts. Also, the yoke 112 defines the beam hole 120 to pass a laser beam.

The shaft 118 is formed at a bottom center of the yoke 112 and of which free end is inserted into the lens holder 104 for guiding the motion of the lens holder 104.

The operation of the axle-type optical pick-up actuator will now be described.

When the focusing coil 106 is supplied with current, an electromagnetic force is produced between the focusing coil 106 and the magnets 110 to move the lens holder 104 up and down from a disk. The up and down motion of the lens holder 104 is guided by the shaft 118.

When the tracking coils 108 are supplied with current, an electromagnetic force produced between the tracking coils 108 and the magnets 110 rotates the lens holder 104 about the shaft 118.

Since the optical axis of laser beam passes the beam hole 120, when one of the object lenses 101 and 103 is aligned with the beam hole 120, a laser beam is scanned to a disk through the beam hole 120 and the aligned object lens.

The alignment of the object lens 101 and the object lens 103 is carried out depending on the type of a disk. For example, the object lens 101 is aligned with the beam hole 120 for passing a red laser beam therethrough when a CD/DVD is loaded, and the object lens 103 is aligned with beam hole 120 for passing a blue laser beam when a blue laser disk is loaded.

The lens holder 104 is rotated 90° clockwise or counterclockwise about the shaft 118 as shown in FIG. 3. For the rotation of the lens holder 104, the tracking coils 108 are supplied with current to generate an electromagnetic force. Since the electromagnetic force has to be bigger than the attractive force between the magnets 110 and the metal pieces 114 to rotate the lens holder 104, the amount of the current supplying to the tracking coils 108 is determined depending on the attractive force.

In this way, the axle-type optical pick-up actuator can align different types of lens on the optical axis to access different types of disks, such as CD/DVDs and blue laser disks.

However, the 90° rotation of the lens holder 104 causes the lens holder 104 to have bigger size. Further, the alignment between the optical axis and the object lens 101 or 103 can be deviated because of the rotation of the lens holder 104.

Furthermore, the balancing weight 116 on the lens holder 104 decreases the sensitivity of the optical pick-up actuator. Especially, this decrease in sensitivity makes it hard to apply the optical pick-up actuator to high-speed optical storage devices.

### SUMMARY OF THE INVENTION

Accordingly, the present invention is directed to an optical pick-up apparatus with a plurality of lenses that substantially obviates one or more problems due to limitations and disadvantages of the related art.

An object of the present invention is to provide an optical pick-up apparatus with a plurality of lenses, in which an actuator can be carried.

Another object of the present invention is to provide an optical pick-up apparatus with a plurality of lenses, in which the distances among the lenses are the same as the displacements of an actuator.

A further another object of the present invention is to provide an optical pick-up apparatus with a plurality of lenses, in which the lenses are arranged at an angle of 180 degrees from each other to place desired one of the lens on an optical axis by moving an actuator.

A further another object of the present invention is to provide an optical pick-up apparatus with a plurality of lenses, in which the lenses are arranged in a line to place desired one of the lenses on an optical axis by moving an actuator.

A still further another object of the present invention to provide an optical pick-up apparatus with a plurality of lenses, in which a linear driving unit is coupled with an actuator to reciprocate the actuator along a linear path without deviation between the lenses and an optical axis.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an optical pick-up apparatus, including: an actuator having a plurality of lenses to focus lasers with different wavelengths on a track of a disk; and a linear driving unit carrying all the actuator to place one of the lenses on a laser path.

In another aspect of the present invention, there is provided an optical pick-up apparatus, including: a lens holder having a plurality of lenses to focus lasers with different wavelengths on a track of a disk; a frame located a predetermined distance from the lens holder; a plurality of wire suspensions connected between the lens holder and the frame; and a linear driving unit carrying the lens holder and the frame in a linear direction to place one of the lenses on an optical axis in accordance with the type of the disk.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of an axle-type optical pick-up actuator with a dual lens according to the related art;

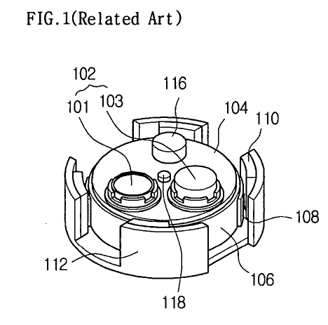

FIG. 2 is an exploded perspective view of an axle-type optical pick-up actuator depicted in FIG. 1;

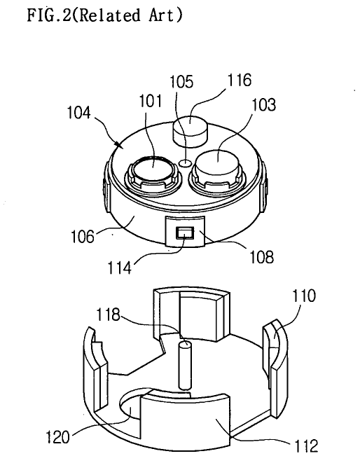

FIG. 3 is a perspective view showing replacement of an object lens of an axle-type optical pick-up actuator depicted in FIG. 1;

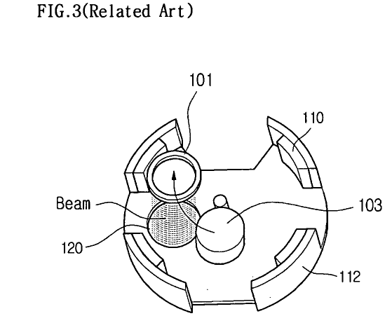

FIG. 4 is a plan view of an optical pick-up apparatus with a plurality of lenses according to the present invention;

FIG. 5 is a plan view of an optical pick-up apparatus with a plurality of lenses, showing an operation of a first object lens according to the present invention;

FIG. 6 is a side view of an optical pick-up apparatus depicted in FIG. 5;

FIG. 7 is a plan view of an optical pick-up apparatus with a plurality of lenses, showing an operation of a second object lens according to the present invention;

FIG. 8 is a side view of an optical pick-up apparatus depicted in FIG. 7;

FIG. 9 is a plan view of an optical pick-up apparatus with a plurality of lenses, in which a linear driving unit is shown according to a first embodiment of the present invention;

FIG. 10 is a plan view of an optical pick-up apparatus with a plurality of lenses, in which a linear driving unit is shown according to a second embodiment of the present invention;

FIG. 11 is a plan view of an optical pick-up apparatus with a plurality of lenses, in which a linear driving unit is shown according to a third embodiment of the present invention; and

FIG. 12 is a plan view of an optical pick-up apparatus with a plurality of lenses, in which a linear driving unit is shown according to a forth embodiment of the present invention;

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

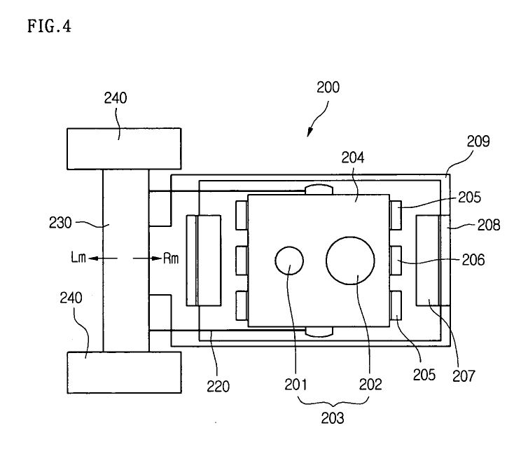

FIG. 4 is a plan view of an optical pick-up apparatus with a plurality of lenses according to the present invention.

Referring to FIG. 4, an optical pick-up apparatus includes: an actuator 200; a lens holder 204 provided with lenses 203; coils 205 and 206 for moving the lens holder 204; magnets 207 facing with the coils 205 and 206; a yoke 209 on which the magnets 207 are fixed; a yoke plate 209 from which the yoke 208 is vertically extended; a frame 230 located a predetermined distance from the lens holder 204; wire suspensions 220 connected between the lens holder 204 and the frame 230 to support the lens holder 204; and a linear driving unit 240 for carrying all the actuator 200 in the directions of arrows Lm and Rm to align any one of the lenses 203 with an optical axis.

The lenses 203 include a first object lens 201 and a second object lens 202 that are arranged in a line (at an angle of 180°).

The actuator 200 with lenses 203 is moved in right and left directions by the linear driving unit 240 (linear reciprocating motion). As with other directional terms, the terms “right” and “left” are used in a relative sense and are not limiting.

For this linear reciprocating motion, the actuator 200 includes the lens holder, a magnetic circuit, the wire suspension 220, and the frame 200.

The lens holder 204 holds the first and second object lenses 201 and 202. The first object lens 201 may be a blue laser lens for an blue laser disk (BD), and the second object lens 202 may be a red laser lens for an compact disk/digital video [versatile] disk (CD/DVD). The locations of the first and second object lenses 201 and 202 can be interchanged with each other.

The first and second object lenses 201 and 202 are located a predetermined distance from each other and their center are aligned in a line.

The coils 205 and 206 are disposed on each side of the lens holder 204. The coils 205 are focusing coils, and the coils 206 are tracking coils. Each of the focusing coils 205 is wounded about a vertical axis, and each of the tracking coils 206 is wounded about a horizontal axis. A tilt coil, (not shown) can be disposed at a predetermined portion of the lens holder 204.

The magnets 207 are fixed to inner surfaces of the yoke 208 to face with the coils 205 and 206. Each of the magnets 207 may include a plurality of unidirectional (unipolar) magnets or a plurality of bipolar magnets or may be a multipolar magnet. The term “unidirectional” is used to denote a magnet with the positive pole on one side and the negative pole on the opposite side, the term “bipolar” is used to denote a magnet with the positive pole and the negative pole on the same side (two poles on the same side), and the “multipolar” is used to denote a magnet with positive poles and negative poles on the same side. For example, according to the polarities of the magnets 207, the focusing coils 205 move the lens holder 204 up and down and the tracking coils 206 move the lens holder 204 right and left.

The yoke 208 and the yoke plate 209 are formed in one piece, and the yoke extends vertically from the yoke plate 209 and. The magnets 207 are attached to inner surfaces of the yoke 208.

The wire suspensions 220 are connected between the lens holder 204 and the frame 230 to support the movement of the lens holder 204 and to supply power to the coils 205 and 206. The frame 230 is provided with a circuit board electrically connected with the wire suspension 220. The number of wire suspension 220 is not critical. For example, two pairs or three pairs of wire suspensions may be connected between the frame 220 and the lens holder 204 according to two-axis or three-axis movement of the lens holder 200. The term “two-axis” is used to denote the focusing and tracking movements of the lens holder 204, and the term “three-axis” is used to denote the focusing, tracking, and tilting movement of the lens holder 204.

The linear driving unit 240 is attached to each side of the frame 230 to move the frame 230 in right and left directions. The linear driving unit 240 includes a linear motor to move the frame toward an optical disk. The distance between rightmost and leftmost positions of the frame 230 is the same as the distance between the first object lens 201 and the second object lens 202.

In the optical pick-up apparatus of the present invention, focusing coils 205, the tracking coils 206, the magnets 207, and the yoke 208 are configured to form a magnetic circuit for the focusing and tracking movement of the lens holder 204.

The actuator 200 moves right or left to align the first object lens 201 or the second object lens 202 with the optical axis of a laser beam in accordance with the type of loaded optical disk. For example, the first object lens 201 is placed on the optical axis, and the second object lens 202 is placed on the optical axis when a CD or DVD is loaded.

Therefore, the linear driving unit 240 may further include a controlling element to judge which object lens is to be placed on the optical axis and to control the movement of lens holder 204.

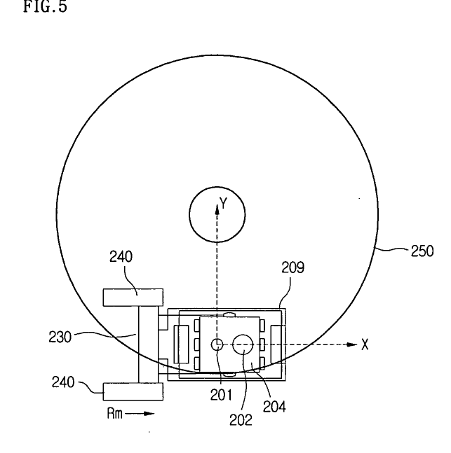

FIG. 5 is a plan view of an optical pick-up apparatus with a plurality of lenses, showing an operation of a first object lens according to the present invention.

Referring to FIG. 5, the frame 230 is moved in the direction of arrow Rm by the linear driving unit 240. That is, the actuator 200 is moved right. Herein, the lens holder 204 is also moved a predetermined distance to the right to place the first object lens 201 on the optical axis. Through the first object lens 201, a laser beam is scanned to a loaded disk (not shown) to access or write data. Herein, the laser beam may be a blue laser beam if the loaded optical disk is a blue laser disk.

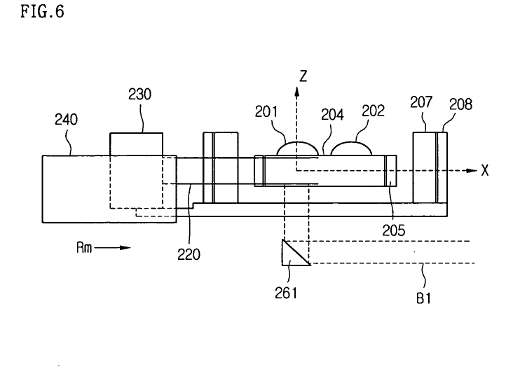

FIG. 6 is a side view of an optical pick-up apparatus depicted in FIG. 5.

Referring to FIG. 6, the linear driving unit 240 moves the frame 230 in the direction of arrow Rm to carry the lens holder 204 connected to the frame 230 by the wire suspensions 220. Therefore, the first object lens 201 aligns with the optical axis (Z) and a first laser beam B1 passes through the first object lens 201. For example, a blue laser beam B1 generated by a blue laser diode (not shown) is reflected by a mirror 261 and then scanned to the blue laser disk through the first object lens 201 to access or write data.

When the loaded disk is ejected and a different type of optical disk is loaded, the linear driving unit 240 moves the actuator 200 right along a straight path to place the first object lens 201 on the optical axis (Z). This linear transportation enables exact alignment between the object lens and the optical axis (Z) without deviation when changing the object lens.

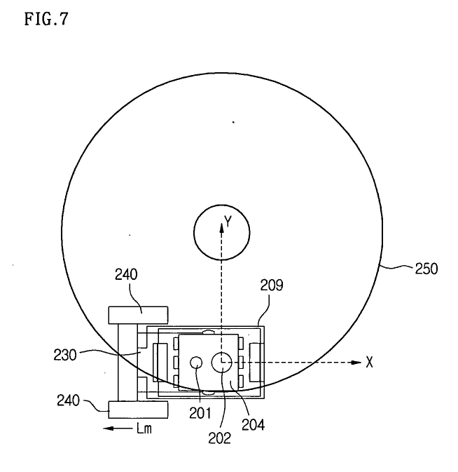

FIG. 7 is a plan view of an optical pick-up apparatus with a plurality of lenses, showing an operation of a second object lens according to the present invention.

Referring to FIG. 7, the frame 230 is moved in the direction of arrow Lm by the linear driving unit 240. That is, the actuator 200 is moved left. Herein, the lens holder 204 is also moved a predetermined distance to the left to place the second object lens 202 on the optical axis. Through the second object lens 202, a laser beam is scanned to the loaded disk to access or write data. Herein, the laser beam may be a red laser beam if the loaded optical disk is a CD or DVD.

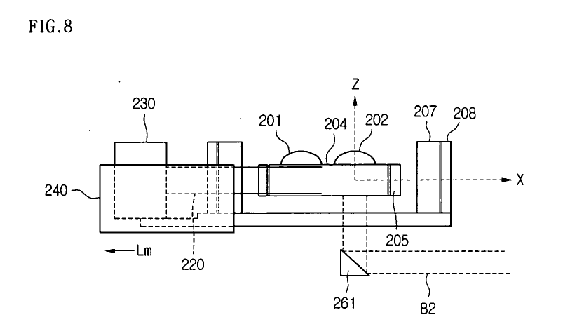

FIG. 8 is a side view of an optical pick-up apparatus depicted in FIG. 7.

Referring to FIG. 8, the linear driving unit 240 moves the frame 230 in the direction of arrow Lm to carry the lens holder 204 connected to the frame 230 by the wire suspensions 220. Therefore, the second object lens 202 aligns with the optical axis (Z) and a second laser beam B1 passes through the second object lens 202. For example, a blue laser beam B1 generated by a blue laser diode (not shown) is reflected by the mirror 261 and then scanned to the loaded CD or DVD through the second object lens 202 to access or write data.

When the loaded disk is ejected and a different type of optical disk is loaded, the linear driving unit 240 moves the actuator 200 left along a straight path to place the second object lens 202 on the optical axis (Z). This linear transportation enables exact alignment between the object lens and the optical axis (Z) without deviation when changing the object lens.

To precisely align the object lenses 201 and 202 with the optical axis (Z), the linear driving unit 240 includes a first portion and a second portion that are synchronized and respectively disposed at both sides of the frame 230. That is, the linear driving unit 240 is tightly abutted on the frame 230 of the actuator 200 and in this condition the linear motor (e.g., piezoelectric motor) of the linear driving unit 240 moves the frame 230. After the frame 230 of actuator 200 is moved to a position where the first object lens 201 or the second object lens 202 is aligned with the optical axis (Z), the actuator 200 is securely fixed at the position owing to the tight abutment between the linear driving unit 240 and the frame 230 (i.e., degree of freedom is zero), thereby preventing deviation error.

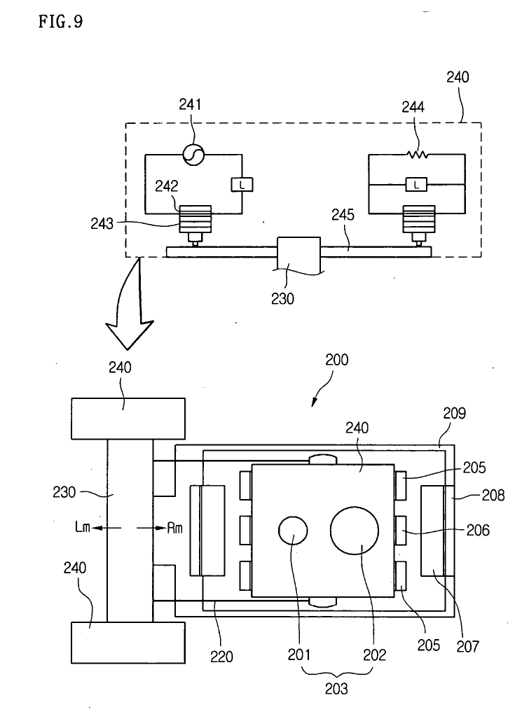

FIG. 9 is a plan view of an optical pick-up apparatus with a plurality of lenses, in which a linear driving unit is shown according to a first embodiment of the present invention.

Referring to FIG. 9, a linear driving unit 240 utilizes a surface wave type piezoelectric motor. The linear driving unit 240 includes a generator 241, a piezoelectric vibrator 242, an amplifying plate 243, and a guide rod 245. The linear driving unit 240 enables a linear reciprocating motion of an actuator 200 and does not allow any other motion of the actuator 200. For this purpose, the piezoelectric vibrator 242 and the amplifying plate 243 are pressed to keep frictional contact between the linear driving unit 240 and a frame 230 of the actuator 200, and a linear motor such as a piezoelectric ultrasonic motor is used to move the actuator under the frictional contact condition.

In operation of the piezoelectric ultrasonic motor, the piezoelectric vibrator 242 vibrates when the generator 241 is powered on. The vibration of the piezoelectric vibrator 242 is transmitted to the frame 230 through the guide rod 230 to move the frame 230 in a linear direction. In detail, the vibration of the piezoelectric vibrator 242 creates an elliptical trajectory on the surface of the piezoelectric vibrator 242, and the amplifying plate 243 of which length is larger than the wave length of the vibration of the piezoelectric vibrator 242 is disposed on the piezoelectric vibrator 242 such that the amplifying plate 243 comes into contact with the piezoelectric vibrator 242 when the vibration displacement of piezoelectric vibrator 242 is at about a maximum. The corresponding movement of the amplifying plate 243 moves the guide rod 245 and therefore the frame 230 coupled with the guide rod 245 is carried right or left. Herein, the reference numeral 244 denotes a load resistor.

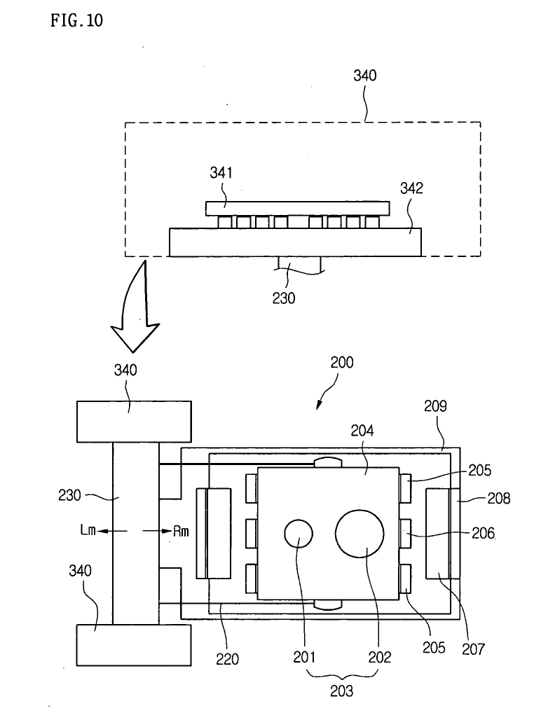

FIG. 10 is a plan view of an optical pick-up apparatus with a plurality of lenses, in which a linear driving unit is shown according to a second embodiment of the present invention.

Referring to FIG. 10, a linear driving unit 340 utilizes a progressive wave type piezoelectric motor. The linear driving unit 340 includes a fixed vibrator 341 and a metallic friction body 342. A progressive surface wave is generated on each side of the fixed vibrator, and a pressing and frictional force resulting from the surface wave moves the metallic friction body 342. Therefore, a frame 230 of an actuator 200 is carried. This piezoelectric motor structure provides a precise transportation even when there is an external or internal disturbance. The actuator 200 may be symmetrically provided with the piezoelectric motor structure. Also, the actuator 200 may be provided at one side with the piezoelectric motor structure when there is a spatial limit.

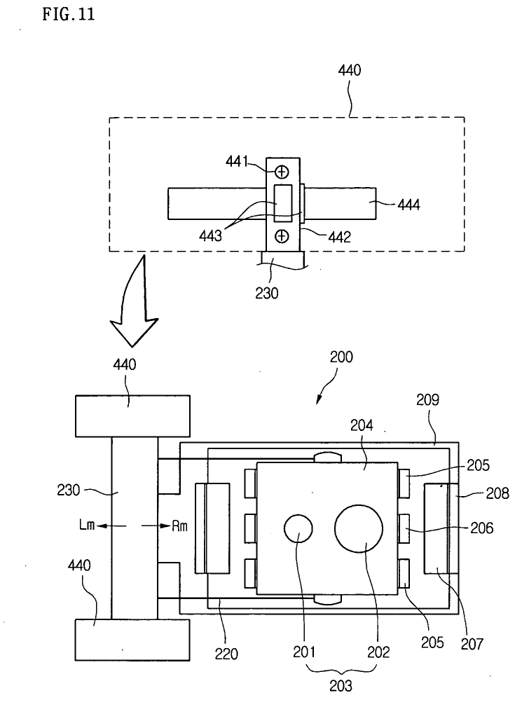

FIG. 11 is a plan view of an optical pick-up apparatus with a plurality of lenses, in which a linear driving unit is shown according to a third embodiment of the present invention.

Referring to FIG. 11, a linear driving unit 440 utilizes a dual mode tuning piece type piezoelectric motor. The linear driving unit 440 includes screws 441, tuning pieces 443, a piezoelectric ceramic 442, and a rail guide 444. The tuning pieces 443 are fixed using the screws 441, and a spring (not shown) is disposed between the tuning pieces 443. The tuning pieces 443 vibrate to move the piezoelectric ceramic 442 along the rail guide 444 to carry a frame 230 of an actuator 200 to the direction of arrow Rm or Lm.

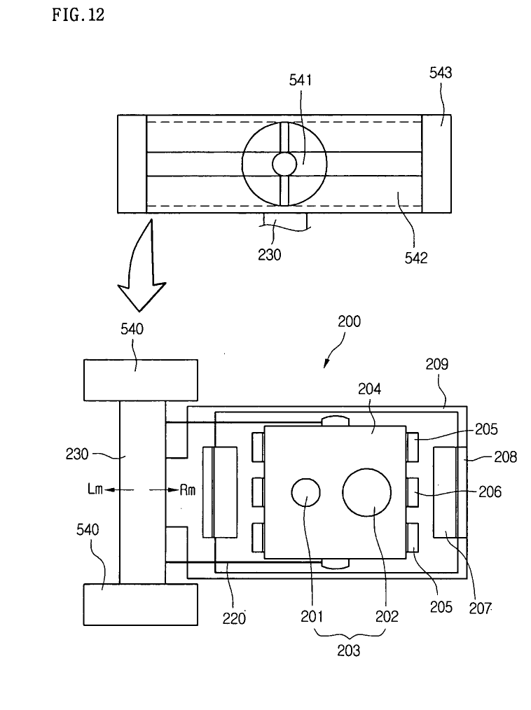

FIG. 12 is a plan view of an optical pick-up apparatus with a plurality of lenses, in which a linear driving unit is shown according to a forth embodiment of the present invention;

Referring to FIG. 12, a linear driving unit 540 utilizes a multi-mode piezoelectric disk type piezoelectric motor. The linear driving unit 540 includes a piezoelectric ceramic 541, a moving rail guide 542, and fixed rail guides 543. The piezoelectric ceramic 541 moves the moving rail guide 542 right or left between the fixed rail guides 543 to carry a frame 230 of an actuator 200.

As described above, the optical pick-up apparatus of the present invention can be applied to the optical system using red laser and blue laser. Also, different types of optical disks can be used in the optical system employing the optical pick-up apparatus of the present invention.

Further, the object lenses are disposed on the lens holder in a linear fashion, and the lens holder is capable of linear reciprocating motion owing to the linear driving unit, such that the lens holder can have simple structure.

Furthermore, the linear driving unit utilizes the piezoelectric motor, such that the actuator can carry the object lenses to align the object lenses on the optical axis without deviation.

It will be apparent to those skilled in the art that various modifications and variations can be made in the present invention. Thus, it is intended that the present invention covers the modifications and, variations of this invention provided they come within the scope of the appended claims and their equivalents.

1. An optical pick-up apparatus, comprising:
an actuator having a plurality of lenses to focus lasers with different wavelengths on a track of a disk; and
a linear driving unit carrying all the actuator to place one of the lenses on a laser path.

2. The optical pick-up apparatus according to claim 1, wherein the linear driving unit reciprocates the actuator along a linear path.

3. The optical pick-up apparatus according to claim 1, further comprising a controller controlling the movement of the actuator to align a proper lens of the lenses with the track of the disk in accordance with the type of the disk.

4. The optical pick-up apparatus according to claim 1, wherein the actuator is carried the same distance as the distance between the lenses.

5. The optical pick-up apparatus according to claim 1, wherein the actuator comprises:
a lens holder holding the lenses;
a magnetic circuit provided with a coil, a magnet, and a yoke that are arranged around the lens holder;
a plurality of wire suspensions for supporting the lens holder; and
a frame spaced apart from the lens holder to support the wire suspensions, the frame being coupled with the yoke.

6. The optical pick-up apparatus according to claim 5, wherein the linear driving unit is coupled to a predetermined side of the frame.

7. The optical pick-up apparatus according to claim 5, wherein the yoke comprises a yoke plate and a vertical part extended from the yoke plate, and the linear driving unit is coupled to a predetermined portion of the vertical part or the yoke plate.

8. The optical pick-up apparatus according to claim 5, wherein the lenses are arranged in a line perpendicular to a tracking direction of the lens holder, the lenses being spaced apart from each other.

9. The optical pick-up apparatus according to claim 5, wherein the lenses are arranged at an angle of 180 degrees to each other.

10. The optical pick-up apparatus according to claim 5, wherein the lenses comprise a red laser lens and a blue laser lens.

11. The optical pick-up apparatus according to claim 10, wherein the red laser lens is an object lens for a compact disk (CD) and a digital video/versatile disk (DVD).

12. The optical pick-up apparatus according to claim 10, wherein the blue laser lens is an object lens for a blue laser disk (BD).

13. The optical pick-up apparatus according to claim 1, wherein the linear driving unit comprises a piezoelectric motor to carry the actuator.

14. The optical pick-up apparatus according to claim 13, wherein the piezoelectric motor is a motor selected from the group consisting of a surface wave type piezoelectric motor, a progressive wave type piezoelectric motor, a dual mode tuning piece type piezoelectric motor, and a multi-mode piezoelectric disk type piezoelectric motor.

15. An optical pick-up apparatus, comprising:
a lens holder having a plurality of lenses to focus lasers with different wavelengths on a track of a disk;
a frame located a predetermined distance from the lens holder;
a plurality of wire suspensions connected between the lens holder and the frame; and
a linear driving unit carrying the lens holder and the frame along a linear path to place one of the lenses on an optical axis in accordance with the type of the disk.

16. The optical pick-up apparatus according to claim 15, wherein the lens holder is carried the same distance as the distance between the lenses.

17. The optical pick-up apparatus according to claim 15, wherein the lenses comprises:
a red laser lens for focusing a red laser beam on a CD/DVD; and
a blue laser lens for focusing a blue laser on a BD.

18. The optical pick-up apparatus according to claim 15, further comprising:
a focusing coil and a tracking coil that are fixed to predetermined sides of the lens holder;
a magnet facing with the focusing coil and the tracking coil; and
a yoke bent from a yoke plate to support the magnet and the frame.

19. The optical pick-up apparatus according to claim 15, wherein the linear driving unit is a piezoelectric motor disposed at a predetermined side of the frame.

20. An optical pick-up apparatus, comprising:
an actuator having a lens holder on which a red laser lens and a blue laser lens are closely arranged in a line; and
a linear driving unit coupled with the actuator to carry the actuator along a linear path to place the red laser lens or the blue laser lens on an optical axis.
